(19) United States
(12) Patent Application Publication
(10) Pub. No.: US 2003/0149986 A1
(43) Pub. Date: Aug. 7, 2003

(54) Security system for defeating satellite television piracy

(76) Inventors: William W. Mayfield, Anaheim Hills, CA (US); Charles P. Rubin, Los Angeles, CA (US)

Correspondence Address: DRUMMOND & DUCKWORTH, East Tower, 5000 Birch Street, Suite 440, Newport Beach, CA, 92660, US

(21) Appl. No.: 10/374,375

(22) Filed: Feb. 25, 2003

Related U.S. Application Data
(63) Continuation-in-part of application No. 10/246,868, filed on Sep. 17, 2002.
(63) Continuation-in-part of application No. 09/371,316, filed on Aug. 10, 1999, now Pat. No. 6,522,865.
(60) Provisional application No. 60/398,502, filed on Jul. 23, 2002.

(51) Int. Cl. H04N 7/20

(52) U.S. Cl. 725/63; 725/73

(57) ABSTRACT

An authorization system is provided for controlling access to satellite television services. The authorization system includes one or more earth orbiting satellites. The authorization system includes a terrestrial television supplier, one or more orbiting satellites, and a plurality of television units. The authorization system may include a terrestrial cable system for transmitting television signals to the television units. However preferably, the one or more satellites include a first transceiver for receiving and transmitting television signals which are relayed from the television service provider to the television units. Moreover, the satellites are provided with a second transceiver for receiving and transmitting authorization request signals which are transmitted by the television units and relayed by the satellites for receipt by the terrestrial television supplier. The authorization request signals are initiated by commands and are automatically sent by the television units, or initiated by commands initiated by a television watcher into the television unit. The authorization request signals may include authentication signals or may include pay-per-view requests, service change requests, tech services, audio services, video conferencing, Internet access, etc. Moreover, the authorization request signals may be encrypted or used to enable encryption using various formats such as public key/private key encryption systems. Preferably, television signals are transmitted by the satellite to the television units in X-band or K-band. Meanwhile, preferably the authorization request signals and control signals not integrated within the television signals are transmitted and received by the television units in L-band or S-band.

### RELATED APPLICATIONS

This application is a continuation-in-part application of provisional application Serial No. 60/398,502 filed on Jul. 23, 2002, and a continuation-in part application of U.S. application Ser. No. 10/246,868 filed on Sep. 17, 2002, which, in turn, is a continuation-in-part application of U.S. application Ser. No. 09/371,316 filed on Aug. 10, 1999.

### BACKGROUND OF THE INVENTION

The present invention concerns systems for protecting the transmission of information. More particularly, the present invention relates to protecting information that is transmitted by cable and wireless communication systems against unauthorized access.

Information and the number of features being made available to subscribers of subscription television systems are continually increasing. For example, cable television and satellite television networks provide an almost limitless supply of information and features. Already, subscription television systems are being used for traditional television programming, pay-per-view programming, impulse pay-per-view programming, and favorite channel features. Television system operators are also providing relatively new features such as digital audio services, Internet networking, home shopping, video conferencing, and burglary and fire alarm services. Each of these services is provided at a price to the consumer, so the service provider requires the ability to authorize and deny services to individual subscribers. Moreover, certain services require a subscriber to request authorization for a particular service impulsively, for example where a subscriber wishes to view a movie of their choice without having to pre-order the movie in advance.

Typically, a television service provider generates a television signal for transmission by cable or satellite to a television unit. The television signal includes an interactive portion consisting of application code or control information, as well as an audio-visual portion such as a television program. The television service provider combines the interactive portion and audio-visual portions into a single signal for transmission to the television's receiver. The signal is generally compressed prior to transmission to the television unit.

To control access to the television services, the television unit typically includes a set-top box, which is provided by the television service provider. The set-top box receives the television signal transmitted by the television service provider, separates the interactive portion from the audio-video portion and decompresses the respective portions of the signal. The set-top box uses the interactive information, for example, to execute an application, while the audio-video information is produced by the television unit. The interactive information may control access to video or audio information to the television user. Alternatively, the interactive information may prompt the viewer for input. The input may be used by the set-top box to control television functions, or the input may be transmitted as an authorization request to the television service provider, such as by cable or telephone lines.

One solution to providing secure terminal authorization is to transmit authorization codes to the television unit in an encrypted format, thereafter requiring decryption by the television unit. Presently, it is known to utilize so called public key/private key encryption systems and algorithms. Two examples of these include (RSA), which stands for the initials of the inventors of this protocol, and digital signal algorithm (DSA), which are described in U.S. Pat. Nos. 4,405,829 and 5,231,668, respectively. Implementation of either of these examples require that, on command, the set-top box generate a public key which must be transmitted to the television service provider to enable encryption of the authorization codes and a private key which must be used to decrypt the codes. Public key/private key encryption could be used to implement a robust security system; however, a reliable return link is required to transmit the public key to the television service provider.

Current conditional access systems rely heavily on codes that depend on a unique ID being stored within the user's set-top box, usually within a “smart card” inserted into the box. For example, U.S. Patent No. RE 33,189 describes an encryption mechanism for providing conditional access to a satellite television system. A program is encrypted at the service provider using a frequently changing random number. The random numbers (authorization codes) are encrypted with a key and broadcast along with the program to customer sites. Customers who have paid are then provided the key which is encrypted with a unique ID that is embedded in the user's set-top unit. The set-top units can decrypt the key using the unique ID. Furthermore, the customer's set-top unit decrypts the random numbers, as they are broadcast, and uses the random numbers and key to decrypt the program.

Unfortunately, traditional encryption methods are susceptible to television piracy. In the past, television pirates have devised ingenious decryption techniques to obtain access to cable television networks and satellite television networks without authorization. Since current satellite television security depends primarily on a unique ID buried within the set-top box, piracy may be accomplished by cloning these boxes.

In order to reduce television piracy, television providers have recognized that a conditional access system must have a mechanism that allows the television provider to authenticate the identity of a subscriber. Preferably this authentication is provided often, such as on a monthly or daily basis; or authentication could be provided as a part of an encryption system each time a critical command is sent to the set-top box. To provide such authentication, a real-time telephone return line could be used; however, many set-top boxes do not have access to a telephone line. Telephone return paths are described within U.S. Pat. Nos. 4,792,848; 5,053,883 and 5,270,809 among others. Alternatively, cable television systems often include a cable which provides a return path for transmitting an authorization request from a subscriber to the television provider. As used herein, “authorization requests”, “authorization signals” and “authorization information” is intended to be used in its broadest sense to include subscriber identification and authentication information, and requests for services such as for pay-per-view services, home shopping services, audio service, Internet access, etc.

Unfortunately, satellite television systems, such as provided by DirecTV™ and Dish Network™ are not ideally constructed to utilize a telephone return link or cable return link. In particular, though satellite television providers will sometimes use a telephone line for subscribers to send authorization information, such as for providing a return link for requesting television services, many set-top boxes currently in service do not have convenient access to a telephone line. Adequate security requires that a return link be available to all set-top boxes within the system whenever required to set up encrypted links and to send authentication information.

Thus, it would be advantageous to provide an improved method and system for controlling the access of programming and services to subscribers of a satellite television system. Moreover, it would be advantageous to provide an authorization system for controlling access to satellite television signals which does not require a return link through a telephone line or a cable network.

### SUMMARY OF THE PRESENT INVENTION

Briefly, in accordance with the invention, an improved apparatus and method is provided for controlling the access of satellite television signals to subscribers. More particularly, the invention is a hybrid satellite communications system which includes a return link to enable television subscribers to send communications, such as authorization requests, from their television unit to the satellite television provider. To this end, the satellite television system includes one or more satellites, one or more terrestrially based television providers and a plurality of television units. The satellites include a first transceiver for receiving and transmitting television signals from the television provider to the television units. The television signals include audio-video information which is viewed and heard by the individual subscribers and interactive information which is used to control access to television services. Meanwhile, the satellites include a second transceiver for receiving and transmitting authorization request signals sent from the subscriber's television units to the television service provider. The authorization request signals may include any type of information which may be used by a subscriber to identify himself and/or make requests for services. The television services may include, but are not limited to, requests to modify subscriber programming, requests for pay-per-view programming, requests for parental controls, requests to initiate, alter or maintain television communications, etc. The authorization request signals may also include information for authenticating the user's access to television programming. In a preferred embodiment, the authorization requests are used to enable private key/public key encryption methods, or other known security protocols to provide security in both the forward and return directions for critical control and authentication information.

Because the satellite television signals from the television service provider typically include substantially more information than the authorization request signals sent by the subscriber's user unit, it is preferred that the television signals be transmitted at a significantly higher frequency band than the authorization request signals. More particularly, it is preferred that the satellite television communication system transmit the television signals from the satellites to the user's television unit in X-band and/or K-band. More preferably, the television satellite communications system uses a standard Ku-band Direct Broadcast System (DBS) satellite to send the downlink television signals from the television service provider to the subscriber's television unit. DBS refers to satellite transmission of signals dedicated by the U.S. Federal Communications Commission (FCC) in the electromagnetic spectrum from 12.2 GHz to 12.7 GHz. This frequency band has been reserved primarily for the transmission of television signals.

Meanwhile, it is preferred that the return link authorization request signals be transmitted from the subscriber's television unit to the satellite system in L-band or S-band or both. To this end, it is preferred that the satellite system includes a transceiver in the form of a Mobile Satellite System (MSS) satellite receiving signals between 1.0 GHz and 3.0 GHz, though the relay of signals between 1.9 GHz and 2.2 GHz is even more preferable.

In one alternate embodiment of the invention, all or a portion of the interactive information (including authorization codes) generally included with the television signals and used to control access to the television service will be transmitted separately from audio-visual information. The separate signals containing this interactive information will be referred to as control signals and will be transmitted from the earth orbiting satellite to the subscriber's television units preferably using L-band or S-band.

In another alternative embodiment of the invention, the satellite return link construction is provided to control access to a cable television system. To this end, television programming is transmitted to a subscriber's television unit through a traditional cable network. However, instead of utilizing a telephone return link or a cable return link, the user unit transmits authorization requests by a satellite system. Again, preferably the television unit transmits authorization requests in L-band or S-band to an orbiting satellite which in turn transmits the authorization request signals to the terrestrial based cable television provider.

Other aspects and advantages of the invention will be apparent from the following detailed description and the accompanying drawings illustrating by way of example the features of the present invention.

### BRIEF DESCRIPTION OF THE DRAWINGS

FIG. 1 is a diagram showing an overview of the principal elements of the authorization system for controlling the access to satellite television signals of the present invention;

FIG. 2 is a diagram illustrating the frequency sub-bands as allocated in a preferred embodiment of the present invention;

FIG. 3 is a block diagram showing the interrelationship between ground stations, orbiting satellites and television units for providing communications between a television unit and a television service provider as practiced by the present invention;

FIG. 4 is a block diagram illustrating one embodiment of the satellite signal processing as practiced by the present invention;

FIG. 5 illustrates a preferred embodiment of the present invention in which the satellite divides its territorial coverage into cells;

FIG. 6 is a block diagram illustrating a television unit connected to a television service provider through a satellite communications system of the present invention; and

FIG. 7 is block diagram illustrating a preferred embodiment of the authorization system for controlling access to cable television signals of the present invention.

### DETAILED DESCRIPTION OF THE PREFERRED EMBODIMENTS

While the present invention is susceptible of embodiment in various forms, there is shown in the drawings and will hereinafter be described the presently preferred embodiments of the invention with the understanding that the present disclosure is to be considered as an exemplification of the invention and is not intended to limit the invention to the specific embodiments illustrated.

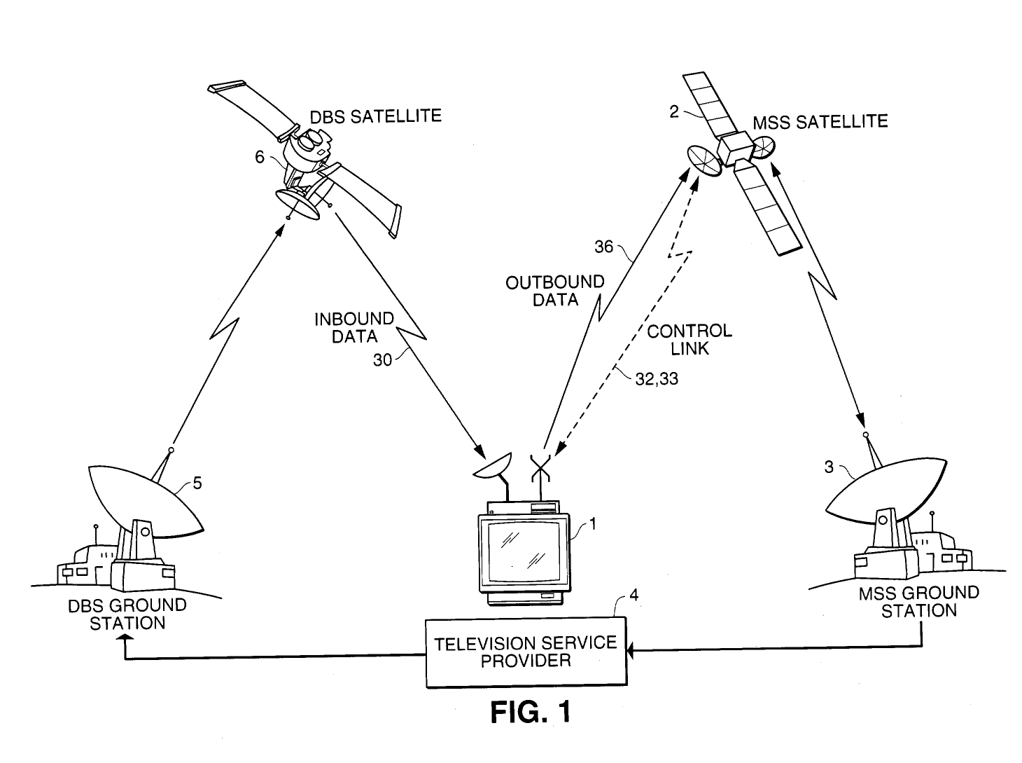

Referring to FIGS. 1-3, the present invention is directed to a hybrid satellite television system which is particularly adapted to providing and controlling the access of television services to a television user. The hybrid satellite television system includes a plurality of television units 1, each typically including a video monitor, speaker assembly and a set-top box. The set-top box includes means for inputting commands, including authorization requests. Commands will often be automatic commands initiated by the television service provider through the interactive portion of the television signals in order to provide authentication or to transmit the keys required to set up an encrypted link. The set-top box further allows for inputting manual commands which may take various forms as can be determined by those skilled in the art such as a push-button keypad on the exterior of the set-top box or a remote control including push button keys.

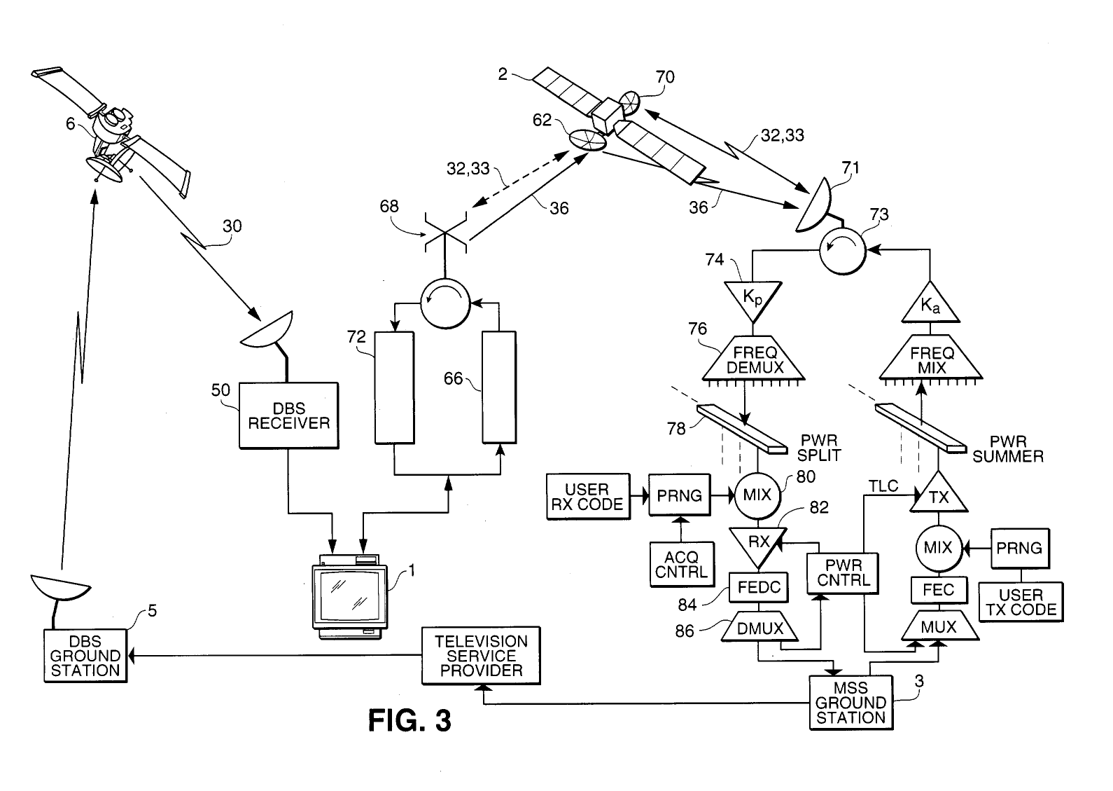

The hybrid satellite television system further includes a satellite system and a terrestrial communications system. The satellite system includes a first transceiver 6 for receiving television signals from the television service provider and for transmitting those television signals to the user's television unit 1. The satellite system further includes a second transceiver 2 for receiving authorization request signals 36 transmitted from a user's television unit 1 and for relaying those authorization request signals back to the terrestrial based television service provider. As shown in FIGS. 1 and 3, preferably the terrestrial communications system includes separate ground stations 3 and 5 for receiving the authorization request signals relayed by satellite 2 and for transmitting television signals relayed to the user's television unit by satellite 6, respectively. The terrestrial communications system, as shown with ground stations 3 and 5, is connected to a television service provider through a high speed cable network or through a similar infrastructure known to those skilled in the art.

Of importance to the practice of the present invention, the downlink television signals 30 are transmitted at a substantially higher frequency than the uplink authorization request signals 36. In order to overcome the disadvantages of the prior art, the present invention provides a highly efficient hybrid communications system in which the downlink television signals are preferably transmitted in X-band and/or K-band while the uplink authorization request signals are transmitted in L-band and/or S-band. For purposes of the present invention, these bands are defined as follows.

| Band | Frequency (GHz) | Wavelength (cm) |
|---|---|---|
| P | 0.225-0.390 | 133.3-76.9 |
| L | 0.390-1.550 | 76.9-19.3 |
| S | 1.55-5.20 | 19.3-5.77 |
| X | 5.20-10.90 | 5.77-2.75 |
| K | 10.90-36.00 | 2.75-0.834 |
| Q | 36.0-46.0 | 0.834-0.652 |
| V | 46.0-56.00 | 0.652-0.536 |
| W | 56.0-100.00 | 0.536-0.300 |

*C Band includes 3.90-6.20 GHz

Even more preferably, the downlink television signals are provided by a DBS satellite 6 transmitting at between 12.2 GHz and 12.9 GHz while the uplink authorization request signals are transmitted at between 1.0 GHz and 3.0 GHz to an MSS satellite 2. The use of two satellites which transmit and receive signals at substantially different frequency bands is ideal for practicing the present invention as television signals typically require substantially higher frequency transmission rates to transmit audio-video information from the television service provider than is required to transmit interactive information to the television unit.

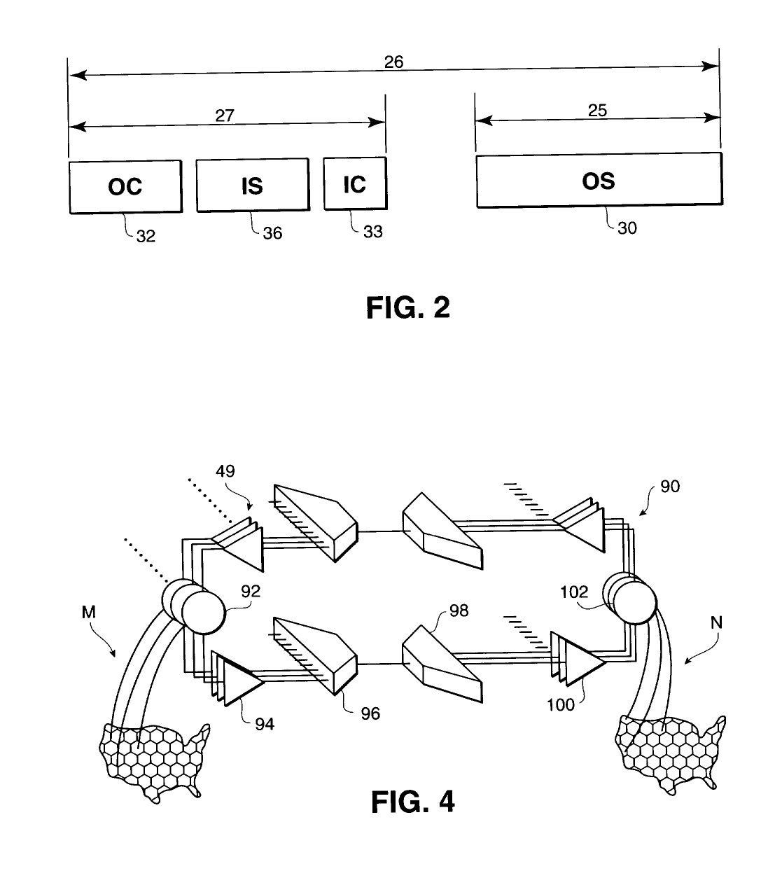

Referring to FIG. 2, the allocated frequency band 26 of the hybrid communications system is divided into two primary sub-bands 25 and 27. Sub-band 27 is dedicated to low frequency communication between the user's television unit 1 and MSS satellite 2 and includes three (3) lesser sub-bands, outbound calling and command sub-band 32, inbound satellite sub-band 36 and inbound calling and tracking sub-band 33. The frequency band between the user's television unit 1 and MSS satellite 2 typically requires three (3) sub-bands as the MSS satellite will typically operate using a time division multiple access (TDMA) or code division multiple access (CDMA) protocol which require synchronization and tracking. Synchronization and tracking may be accomplished using digital information within the television signal (in which case sub-band 32 may not be utilized) or it may require communication between the television unit 1 and MSS satellite through sub-bands 32 and 33. When the television unit is commanded to transmit data or information to the television service provider 4, this information is transmitted in the frequency sub-band designated inbound satellite 36. The frequency sub-bands are identified as follows.

OS: Outbound Satellite 30 (satellite to television unit)

OC: Outbound Calling and Command 32 (satellite to television unit)

IS: Inbound Satellite 36 (television unit to satellite)

IC: Inbound Calling and Tracking 33 (television unit to node)

Meanwhile, communication between the DBS satellite 6 and the user's television unit 1 would typically be transmitted through frequency division multiple access (FDMA) which does not require two-way synchronization and tracking. Accordingly, the entire high frequency sub-band 25 can be dedicated to the transmission of television signals on the sub-band designated outbound satellite 30.

Referring back to FIGS. 1 and 3, in operation, the user 1 will utilize a first fixed antenna with a moderate gain to initiate the communications to the television service provider. The user may respond to an automatic command from the television service provider or may enter manual commands into the set-top box of his television unit. In either case, the commands are relayed by the satellite system to the television service provider. Typically, this is done by initiating communication in the IC sub-band. This call is heard by the MSS satellite 2 which forwards the call to the MSS ground station 3. The call handling element then initiates a handshaking function with the calling unit over the OC 32 and IC 33 sub-bands, leading finally to transmission of the authorization request signal to the television service provider 4. This communication link is through the MSS satellite 2 using, in one embodiment, either L- or S-band frequencies. Preferably, the antenna used for this link is a patch antenna with gain at least 0 dB or a yagi antenna with a gain up to 12 dB. These antennas have a beamwidth of at least 60° which is very easy to install. The resulting digital communication can take place at varying bit rates using standard digital formats, typically sent in short bursts. The signal is then processed in the MSS ground station 3 which sends it to the television service provider 4. The television service provider 4 automatically processes the authorization request signals by means well known in the art and sends the desired television services keys to the DBS ground station which processes the signal and sends it to the DBS satellite by means well known in the art. The DBS satellite then sends the signal to the user. The user receives the signal by means of a standard 18″ DBS receive only antenna. Alternatively, the satellite service provider sends the keys to the MSS ground station for relay to the user. For simplicity, as shown in FIGS. 1 & 3, the user's television unit includes two antennas, with a first antenna for communication with the MSS satellite and the second antenna for receiving signals from the DBS satellite. However, as would be understood by those skilled in the art, these two antennas may be combined in a single antenna structure for communicating with both the MSS satellite and the DBS satellite.

Referring also to FIG. 3, a block diagram is shown of a typical transmission of an authorization request signal from a television unit 1 to MSS satellite 2 to MSS ground station 3 and the processing involved in the user unit 1 and the MSS ground station 3. In transmitting an authorization request signal, the user's television unit 1 is commanded to transmit an authorization request signal to the television service provider 4. The authorization request signal is processed through the transmitter processing circuitry 66, which if transmitted by CDMA protocol, includes spreading the signal using a calling spread code. The signal is radiated by the moderate gain antenna 68 and received by the MSS satellite 2 through its narrow beamwidth antenna 62. The satellite processes the received signal as will be described below and sends it to the MSS ground station by way of its backhaul antenna 70. On receive, the antenna 68 of the user's television 1 receives the television signal and the receiver processor 72 processes the outbound control signal 32.

The MSS ground station 3 receives the signal at its antenna 71, applies it to a circulator 73, amplifies 74, frequency demultiplexes 76 the signal separating off the composite signal which includes the signal from the user shown in FIG. 3, splits it 78 off to one of a bank of code correlators, each of which comprises a mixer 80 for removing the spreading and identification codes, an AGC amplifier 82, the FECC demodulator 84, a demultiplexer 86 and finally the signal is then routed to the appropriate land line, such as a high speed cable network. Transmission by the MSS ground station 3 is essentially the reverse of the above described reception operation.

Referring now to FIG. 4, the satellite transceiver 90 of the MSS satellite 2 is shown in block diagram form. Preferably, a circulator/diplexer 92 receives the uplink authorization request signal and applies it to an L-band or S-band amplifier 94 as appropriate. The signals from all the M satellite cells within a “cluster” are frequency multiplexed 96 into a single composite K-band backhaul signal occupying M times the bandwidth of an individual L-/S-band mobile link channel. The composite signal is then split 98 into N parts, separately amplified 100, and beamed through a second circulator 102 to N separate satellite ground cells. This general configuration supports a number of particular configurations various of which may be best adapted to one or another situation depending on system optimization which for example may include considerations related to frequency allocation and subscriber population. Thus, for a low density rural area, one may utilize an M-to-1 (M>1, N=1) cluster configuration of M contiguous cells served by a single common satellite ground node with M limited by available bandwidth. In order to transmit authorization request signals, an M-to-M configuration would provide an “inter-metropolitan bus” which would tie togther all occupants of such M satellite cells as if in a single local calling region. To illustrate, the same cells (for example, Seattle, Los Angeles, Omaha and others) comprising the cluster of M user cells on the left side of FIG. 4, are each served by corresponding backhaul beams on the right side of FIG. 4.

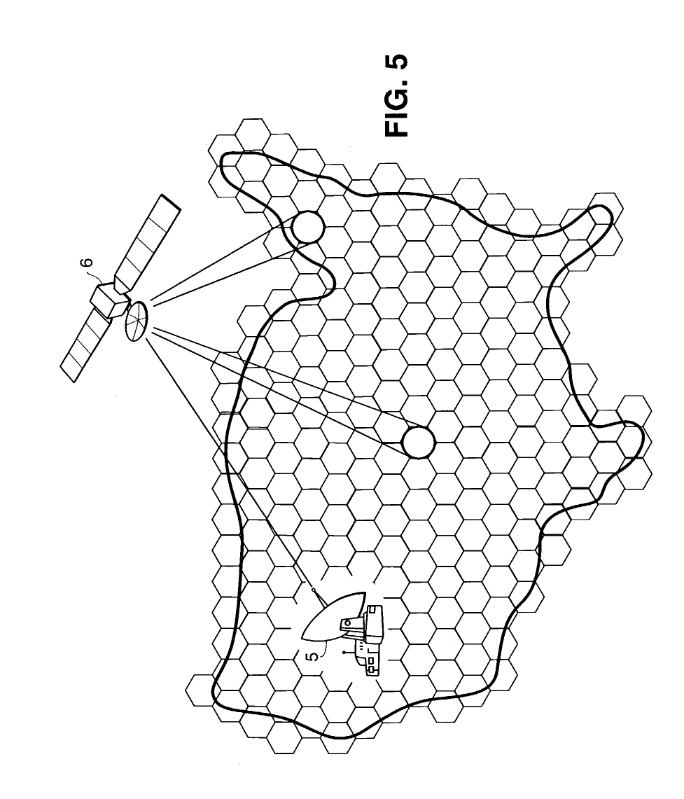

Preferably, MSS satellite 2 and DBS satellite make use of the highest feasible satellite antenna gain. In one embodiment, power gain on the order of 45 dB and beamwidth of under 1 degree are envisioned. This is depicted in FIG. 5 and is accomplished by an antenna size of approximately 20 meters for the MSS satellite. The use of such narrow beams also permits a far more efficient use of spectrum, the other limited commodity, since spectrum can be reused many times with a large number of beams.

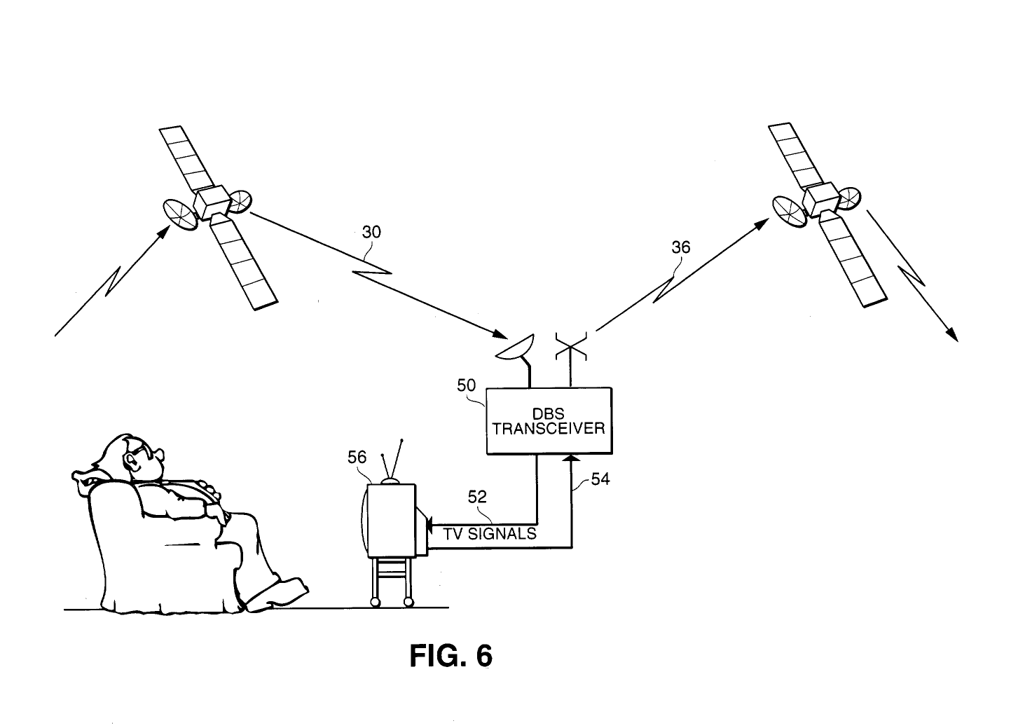

Referring to FIG. 6, the television signals from the DBS satellite are received by the user's DBS antenna typically an 18″ diameter dish and focused on a Low Noise Block downconverter with integrated Feed (LNBF). Signals go from the LNBF to the DBS receiver 50 where they are amplified, decoded and processed. Where the downlink television signals 30 includes both audio-video information and interactive information, the DBS receiver includes a splitter which separates the audio-video information for production on the television and the interactive information for processing by the television's set-top box. The separation of the audio-video information and interactive information can be accomplished by those skilled in the art and is not discussed further herein.

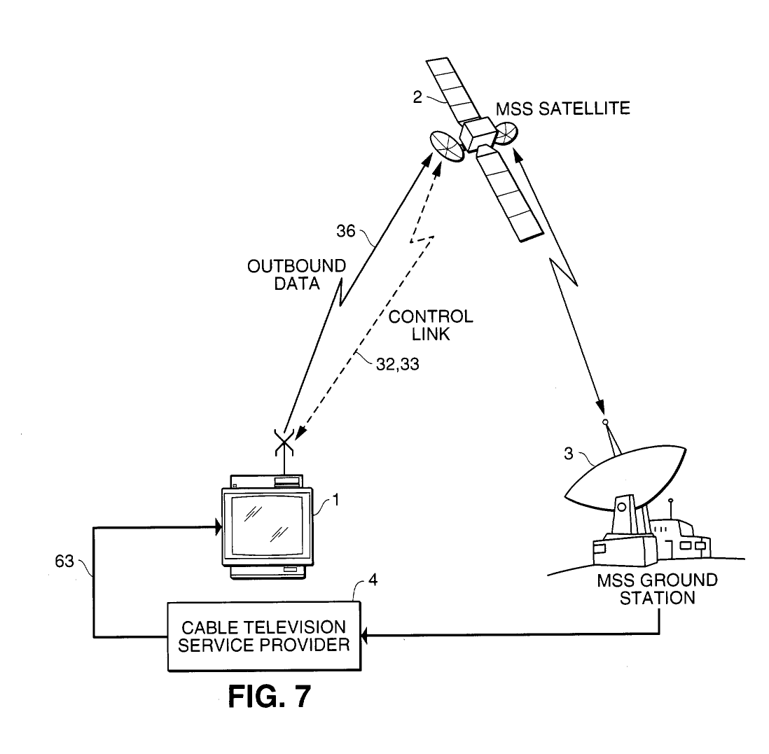

With reference to FIG. 7, in an alternative embodiment of the invention, access and authorization to a cable television service provider is protected by employing a satellite return link for transmitting authorization request signals. The authorization system includes a cable television service provider 4 which provides television services through a cable network 63 to a television unit 1. The television unit 1 includes a transmitter for transmitting authorization request signals to an orbiting satellite. Again, preferably the authorization request signals 36 are transmitted in L-band and/or S-band to the orbiting satellite 2, which in turn, transmits the authorization request signals to a satellite ground station 3. The authorization request signals are then sent to the cable television service provider 4 for processing. Upon receipt, the cable service provider authenticates the authorization request signals and sends the authorization codes to the user.

Having described our invention in such terms as to enable those skilled in the art to understand and practice it, and having defined and identified the presently preferred embodiments thereof, we claim:

1. An authorization system for controlling the access to satellite television signals by television units, the authorization system comprising:
a terrestrial television supplier for transmitting television signals and for receiving authorization request signals;
a plurality of television units including a receiver for receiving said television signals from said terrestrial television supplier and a transmitter for transmitting said authorization request signals;
an earth orbiting satellite means including a transceiver for receiving said authorization request signals from said television units and for transmitting said authorization request signals to said terrestrial television supplier;
said authorization request signals being transmitted by said television units to said satellite means in L band or S band and said authorization request signals being analyzed by said terrestrial television supplier for controlling said television units' access to said television signals.

2. The authorization system for controlling access to television signals of claim 1 further comprising a terrestrial cable system for transmitting said television signals from said terrestrial television supplier to said television units.

3. The authorization system for controlling access to television signals of claim 2 wherein said earth orbiting satellite means includes an MSS satellite for relaying said authorization request signals from said television units to said terrestrial television provider.

4. The authorization system for controlling access to television signals of claim 1 wherein said earth orbiting satellite means includes a transceiver for receiving said television signals from said terrestrial television provider and for transmitting said television signals to said television units.

5. The authorization system for controlling access to television signals of claim 4 wherein said earth orbiting satellite means includes a first DBS satellite for relaying said television signals and a second MSS satellite for relaying said authorization request signals.

6. An authorization system for controlling the access to satellite television signals by television units, the authorization system comprising:
an earth orbiting satellite means including a first transceiver for receiving and transmitting television signals and a second transceiver for receiving and transmitting authorization request signals;
a terrestrial television supplier for transmitting said television signals to said earth orbiting satellite means and for receiving said authorization request signals from said earth orbiting satellite means;
a plurality of television units including a receiver for receiving said television signals from said earth orbiting satellite means and a transmitter for transmitting said authorization request signals to said earth orbiting satellite means;
said televisions signals being transmitted from said satellite means to said television units in X band or K band and said authorization request signals being transmitted by said television units to said satellite means in L band or S band;
said authorization request signals being analyzed by said terrestrial television supplier for controlling said television units' access to said television signals.

7. The authorization system for controlling access to television signals of claim 6 wherein said earth orbiting satellite means includes a first satellite for relaying said television signals and a second satellite for relaying said authorization request signals.

8. The authorization system for controlling access to television signals of claim 6 wherein said earth orbiting satellite means includes a first DBS satellite for relaying said television signals and a second MSS satellite for relaying said authorization request signals.

9. The authorization system for controlling access to television signals of claim 6 wherein:
said terrestrial television supplier includes a transmitter for transmitting control signals to said earth orbiting satellite means;
said earth orbiting satellite means including a transceiver for receiving and transmitting the control signals to said television units; and
said television units include a receiver for receiving control signals from said earth orbiting satellite means; said control signals being transmitted from said satellite means to said television units in L band or S band.

10. The authorization system for controlling access to television signals of claim 9 wherein said earth orbiting satellite means includes a first satellite for relaying said television signals and a second satellite for relaying said authorization request signals.

11. The authorization system for controlling access to television signals of claim 10 wherein said earth orbiting satellite means includes a first DBS satellite for relaying said television signals and a second MSS satellite for relaying said authorization request signals.

12. An authorization system for controlling the access to satellite television signals by television units, the authorization system comprising:
a terrestrial television supplier for transmitting television signals and for receiving authorization request signals;
a plurality of television units including a receiver for receiving said television signals from a terrestrial television supplier and a transmitter for transmitting said authorization request signals;
an earth orbiting satellite means including a transceiver for receiving from said authorization request signals from said television units and for transmitting said authorization request signals to said terrestrial television supplier;
a terrestrial cable system for relaying said television signals from said terrestrial television supplier to said television units;
said authorization request signals being transmitted by said television units to said satellite means in L band or S band and said authorization request signals being analyzed by said terrestrial television supplier for controlling said television units' access to said television signals.

13. The authorization system for controlling access to television signals of claim 12 wherein said earth orbiting satellite means includes an MSS satellite for relaying said authorization request signals.
